(19) United States
(12) Patent Application Publication
(10) Pub. No.: US 2011/0285051 A1
(43) Pub. Date: Nov. 24, 2011

(54) Device And Method For Extruding Plastic Profiles In An Energy Efficient Manner

(76) Inventors: Leopold Hackl, Katzelsdorf (AT); Josef Dobrowsky, Tullnerbach (AT); Georg Lacher, Wien (AT); Miron I. Gorilovskiy, Moskau (RU)

(21) Appl. No.: 13/063,090

(22) PCT Filed: Sep. 10, 2009
(86) PCT No.: PCT/EP09/61780

§ 371 Date: Jul. 28, 2011

(30) Foreign Application Priority Data
Sep. 15, 2008 (DE) 10 2008 047 207.7

(51) Int. Cl. B29C 47/20

(52) U.S. Cl. 264/209.1; 425/461

(57) ABSTRACT

The invention relates to an extrusion line for producing plastic profiles, preferably plastic tubes, comprising at least one extruder (1), a tool (2), a calibrator (3) and additional subsequent devices (4, 5). According to the invention, for cooling the profile (9), the tool (2) has a recess and/or a chamber (11) is arranged about the extruded pipe in order to be able to change the air counter to the direction of extrusion (7). The invention also relates to a method for extruding a plastic profile, in particular a plastic tube, in an energy-efficient manner, said method consisting of the following steps: a) the plastic is melted in an extruder (1); b) a plastic strand is formed and is fed to a tool (2); c) a plastic profile is formed by means of the tool (2) and d) the profile is calibrated and hardened by cooling in a calibrator (3). The profile (9) is externally cooled as well as internally cooled in the calibrator (3). According to the invention, air is suctioned counter to the direction of extrusion (7) for cooling the profile (9).

The invention relates to an extrusion line for producing plastic profiles, preferably plastic pipes, comprising at least one extruder, one die, one calibration means and further following devices. Furthermore, the invention relates to a method for increasing the cooling performance of an extrusion line for extruding a plastic profile, in particular a plastic pipe, which method comprises the following steps: a) melting of plastic in an extruder, b) shaping of a plastic strand and feeding of the plastic strand to a die, c) shaping of a plastic profile by means of the die, d) calibrating and curing by means of cooling of the profile in a calibration means, the profile being cooled in the interior in addition to the outer cooling in the calibration means.

Furthermore, the invention relates to a method for extruding a plastic profile, in particular a plastic pipe, in an energy efficient manner, which method comprises the following steps: a) melting of plastic in an extruder, b) shaping of a plastic strand and feeding of the plastic strand to a die, c) shaping of a plastic profile by means of the die, and d) calibrating and curing by means of cooling of the profile in a calibration means, the profile being cooled in the interior in addition to the outer cooling in the calibration means.

Possibilities of pipe inner cooling are known from the prior art. Thus, for example, DE 69 403 693 proposes to provide the inner wall of the pipe with a spray mist and, as a result, to achieve evaporation of the liquid on the inner wall of the pipe and therefore to achieve cooling. However, cooling means of this type have not proven practical, since the hot water vapor is entrained in the extrusion direction and, although it thus assists the cooling of the pipe in the calibration means, it keeps the pipe at a temperature at the end of the extrusion line, for example in the region of the saw, with the result that, although said pipe is dimensionally stable, it is too soft for the separating process. At the same time, to date there is no concept for the further utilization of the heat occurring due to the inner cooling.

It is therefore an object of the present invention to provide an extrusion line with the aim of removing from the process the heat occurring during the inner and/or outer cooling and making the best possible use thereof.

The object of the invention further comprises the provision of a corresponding method.

The solution of the object with regard to the extrusion line is characterized in conjunction with the preamble of claim 1 in that at least the die has at least one aperture, and an extraction means is arranged in front of the die as viewed in the extrusion direction, by means of which extraction means air in the interior of the plastic profile can be exchanged. The aperture achieves a situation where extraction counter to the extrusion direction is made possible and the heat which is generated in the interior of the profile can be extracted from the process.

The extracted warm air is advantageously fed to a consumer for energy recovery.

This counterflow principle has the advantage that, in comparison with the pipe temperature at the end of the extrusion section, colder air is sucked through the pipe interior counter to the extrusion direction. This air is heated on the pipe inner wall on its path through the pipe, the pipe temperature likewise increasing counter to the extrusion direction. There is therefore always a temperature difference between the air and the pipe inner wall, which results in a permanent heat flow from the pipe into the air. The heat which is extracted from the process in this way is fed to the process again and contributes to the energy optimization. The heat is therefore utilized appropriately and does not disappear into the atmosphere.

As an alternative, it is proposed as a solution in conjunction with the preamble of claim 2 that a chamber is arranged around the extruded pipe following the calibration means, a fan being arranged on the chamber, by means of which fan air can be guided past the outer wall of the extruded pipe counter to the extrusion direction.

It is also of advantage here if the air which is heated in this way is fed to a consumer for energy recovery.

Either extraction or blowing through of the air counter to the extrusion direction is made possible by way of the fan and, as a result, the heat which is present at the outer wall of the profile can be removed from the process. It goes without saying that the entire process can also be operated in the extrusion direction.

The chamber is advantageously sealed at least on one side.

It is proposed to use a preheating station for the raw material to be fed to the extruder as consumer, to which the heat is fed. Plastic granulate is primarily used as raw material; however, said heat can also be used to preheat other materials, such as PVC powder. This has the advantage that the raw material already has a higher temperature than room temperature and therefore less energy has to be applied in the extruder in the form of thermal energy. This also applies, in particular, to the mechanical energy which is introduced. In the case of a single screw extruder, for example, the thermal energy which is applied via the cylinder wall is not so relevant for melting, since here, above all, the mechanical energy (drive energy) is converted into frictional heat.

It goes without saying that the temperature must not lie in a range, in which the plastic granulate which is used already agglutinates. This can be controlled, for example, by the fact that the volumetric flow of the extraction apparatus can be controlled and/or regulated, but also by the fact that the energy which is not required to heat the material is fed to a heat exchanger and/or is used to drive further assemblies, for example a Stirling engine, and/or to produce process cooling. It of course goes without saying that the extracted heat can also be used exclusively only for the drive of the assemblies.

The solution to the object with regard to the method is characterized in conjunction with the preamble of claim 8 in that, for the inner cooling of the profile, the air is sucked through counter to the extrusion direction by means of an extraction means.

As an alternative, for the outer cooling of the profile, it is proposed in conjunction with the preamble of claim 9 to guide the air through a chamber past the outer wall of the extruded pipe counter to the extrusion direction by means of a fan.

There is provision according to one development for the air to be fed to a consumer in order to utilize the heat. As has already been described above, the preheating of granulate or the operation of assemblies, just like the feeding to a heat exchanger or to produce process cooling are provided as consumers.

As has already been mentioned above, the operation using the counterflow principle has the advantage that, in comparison with the pipe temperature at the end of the extrusion section, colder air is sucked through the pipe interior counter to the extrusion direction. Said air is heated on the pipe inner wall on the path through the pipe, the pipe temperature likewise increasing counter to the extrusion direction. There is therefore always a temperature difference between the air and the pipe inner wall, which results in a permanent heat flow from the pipe to the air.

In order to achieve as high as possible a cooling performance, there is provision according to one development for at least one flow speed to be achieved which is situated in the turbulent range. This turbulent flow achieves as satisfactory as possible swirling of the air in the interior and/or on the outer wall of the profile, which leads to a high exchange of the air at the inner and/or outer wall of the profile and results in a satisfactory cooling performance.

In an assisting manner, there is provision according to one development for not only the heat which prevails in the interior of the pipe to be extracted partially via the air and fed to the consumer, but also for the air on the circumference of the pipe to be guided along the pipe, preferably counter to the extrusion direction, which air is heated as has already been described above and in the process also extracts heat from the pipe and the outer diameter and feeds said heat to the consumer.

The methods are particularly appropriate in the case of the extrusion of a thick-walled plastic pipe, since relatively long dwell times of the extrudate in the line are required here and therefore the air volume can be exchanged multiple times, which results in particularly high efficiency.

It is also proposed that heat which accumulates in or on the extruded pipe is fed to the extrusion process again, by air being guided along the surface of the extruded pipe counter to the extrusion direction, and the obtained quantity of heat being utilized to preheat the plastic granulate which is required for the extrusion process or to drive assemblies such as a Stirling engine or to produce process cooling.

The proposed extrusion lines and the proposed methods are suitable, in particular, for thick-walled plastic pipes and pipes with large to very large diameters, the dwell time of which within the extrusion line lies in the range of hours, and is therefore relatively long.

The cooling performance in an extrusion line is increased by means of the proposed invention, with which considerable advantages are associated. Firstly, the overall cooling length is shortened if an existing throughput performance is left unchanged, or the throughput performance can be increased as long as the overall cooling length is retained. Furthermore, energy efficient extrusion of a plastic profile is therefore achieved, since the energy which is extracted from the profile is fed at least partially to the process again.

The extracted air does not influence the melting behavior in the extruder, since it does not come into contact with the extruder. In solutions which are known in the prior art, the air is sucked through the extruder and measures are taken that give no influence. Particularly effective cooling is achieved as a result of the proposed turbulent flow.

In addition to the inner air extraction, there is provision also or as an alternative for air preferably, but not exclusively, to be guided in counterflow over the pipe on the outside. The advantage consists in that a much larger quantity of heat can be extracted from the pipe, which heat can be recycled again partially. The air cooling on the pipe outer diameter can also be used on its own.

Cooling with full water tanks or spray water tanks is known in the prior art. In the case of existing systems, in particular, the outer air cooling means can be an effective retrofitted system, even if the pipe inner cooling is not possible on account of a missing aperture in the pipe head.

It is an aim to keep as high as possible a percentage of the accumulating heat in the system, not only via preheating, but also, for example, via conversion into mechanical drive energy.

Exemplary embodiments of the invention are depicted diagrammatically in the drawings, in which:

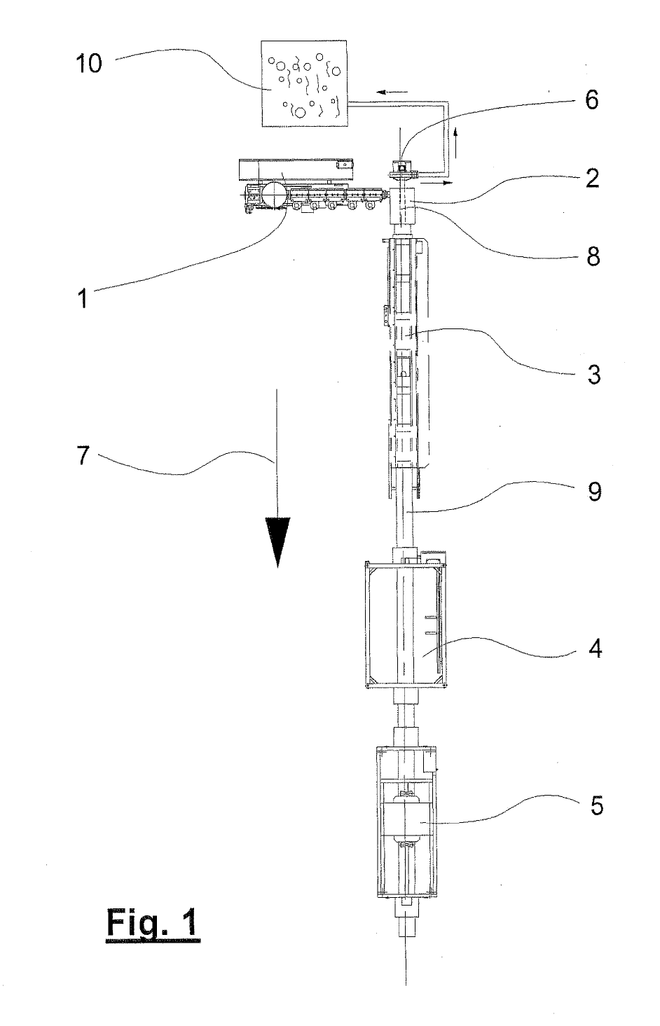

FIG. 1 shows an extrusion line,

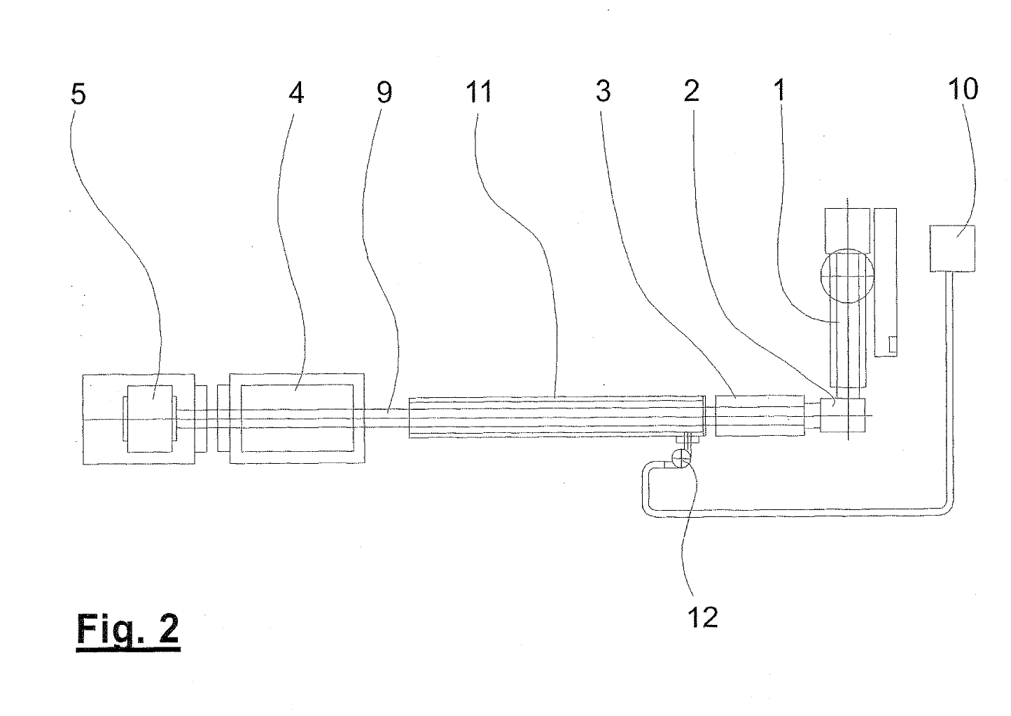

FIG. 2 shows outer cooling of the profile, and

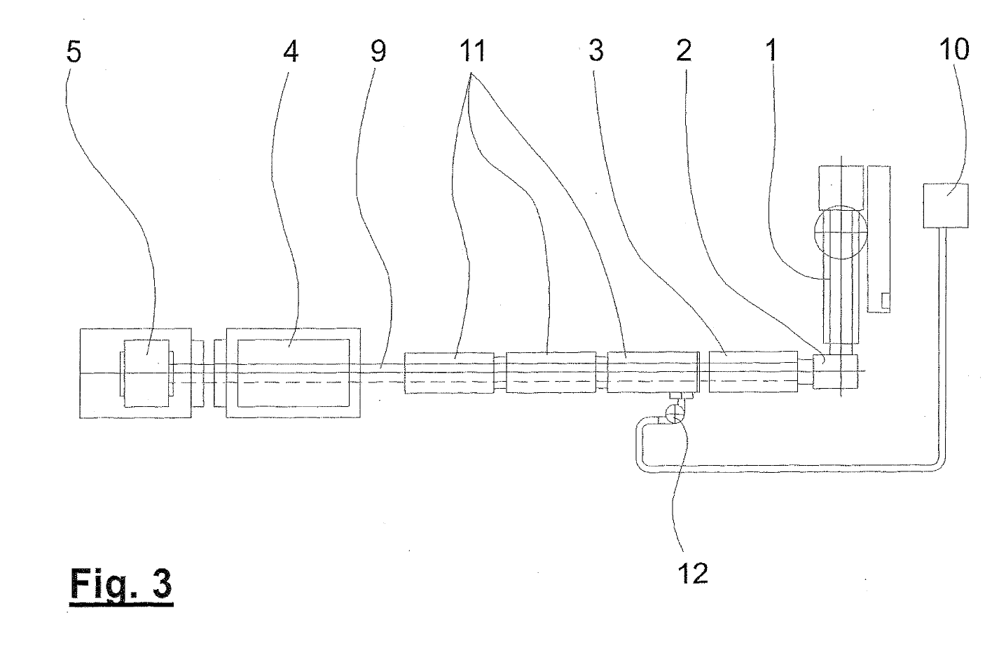

FIG. 3 shows an alternative to FIG. 2.

FIG. 1 diagrammatically shows an extrusion line, the extruder 1 being arranged on the side of the extrusion die 2. As viewed in the extrusion direction 7, the die 2 is adjoined by the calibration means 3 which in turn is followed by the pull-off means 4. The calibration means 3 comprises a vacuum tank with an installed calibration sleeve. Further cooling baths can also adjoin the calibration means.

This is adjoined by a further following device, here a separating apparatus in the form of a saw 5. A pipe 9 is produced in the extrusion line which is shown by way of example. The extraction means 6 is arranged at the start of the extrusion line, directly at the die. The corresponding suction direction is indicated diagrammatically by the arrow. The die 2 has an aperture 8; the aperture 8 is connected to the extraction means 6, with the result that the extraction means 6 can suck through the air volume in the interior of the pipe 9 as far as the end of the extrusion line in the region of the separating apparatus 5.

A consumer 10 is arranged on the extraction means 6, which consumer 10 is, by way of example, a preheating station here for the plastic granulate which is to be fed to the extruder 1. However, a Stirling engine can equally be operated with this, which Stirling engine in turn actuates the pull-off means 4 or other drives of the extrusion line.

The extraction means can be operated intermittently. Air is therefore extracted for a time period t1, as far as possible in the turbulent range, followed by a time period t2, in which extraction is not carried out (tempering time). The heat can therefore again migrate from the center of the pipe wall to the inner side, as a result of which the pipe becomes warmer again on the inner side. This is followed again by a time period t1, in which the heat is extracted. The entire process can be repeated multiple times. An analogous situation applies to the air flow along the outer wall of the profile in the case of outer cooling.

FIG. 2 diagrammatically shows outer cooling of the extrusion line which is shown in FIG. 1 by way of example and once again consists of the extruder 1, the die 2, a calibration means 3, the pull-off means 4 and a separating apparatus 5. A chamber which is once again connected to a fan 12 is arranged around the extruded pipe 9 between the calibration means 3 and the pull-off means 4. The chamber is appropriately sealed with respect to the calibration means 3, with the result that extraction counter to the extrusion direction can be carried out by means of the fan 12. The air which is situated in the space is therefore sucked in at the end of the chamber, that is to say opposite the pull-off means 4, is sucked through along the surface of the pipe 9 counter to the extrusion direction to the exit of the chamber 11, that is to say where the fan 12 is arranged, and is heated on this section and at the same time the outer wall of the pipe 9 is cooled. The air which is heated in this way is fed via the connecting pipes to the consumer 10.

FIG. 3 shows a similar embodiment, in which once again an extrusion line is shown with an extruder 1, an extrusion die 2, the calibration means 3, the pull-off means 4 and a separating apparatus 5. As has already been described with respect to FIG. 1, further cooling baths can be arranged next to the calibration means. This is shown here in FIG. 3 by way of example by way of three cooling baths. Said cooling baths are arranged in such a way that there is a connection between them and once again a fan 12 is arranged at the first cooling bath after the calibration means 3, as viewed in the extrusion direction. Each of said cooling baths is configured in such a way that once again a chamber 11 is produced around the pipe 9. As has already been described in FIG. 2, the compartment air can then be sucked in via the fan 12 on the end face of the chamber 11 which lies opposite the pull-off means 4, and is sucked through along the surface of the pipe 9 in the direction of the fan 12, counter to the extrusion direction. Here too, the air is heated on said path and is fed via the connecting pipes to the consumer 10.

This proposed embodiment is conceivable, for example, in existing pipe extrusion lines, in which the existing cooling baths can be converted into chambers of this type by simple modification and the existing cooling connections can be connected to the fan 12. It goes without saying that it is also conceivable here to arrange the pipe connection to the consumer 10 exactly on the other side of the chambers 11, that is to say just in front of the pull-off means 4, and then not to suck the air through, but rather to blow it through. This would mean that, in the exemplary embodiment according to FIGS. 2 and 3, the fan 12 then sucks in the compartment air and blows it through the chambers along the surface of the pipe 9, where it is fed to the connecting pipes at the other end and is forwarded to the consumer 10.

### LIST OF DESIGNATIONS

1 Extruder
2 Die
3 Calibration means
4 Pull-off means
5 Separating apparatus
6 Extraction means
7 Extrusion direction
8 Aperture
9 Plastic profile
10 Consumer
11 Chamber
12 Fan

1. An extrusion line for producing plastic profiles, preferably plastic pipes, comprising at least
one extruder,
one die,
one calibration means,
and further following devices,
at least the die has at least one aperture, and an extraction means is arranged in front of the die as viewed in the extrusion direction, by means of which extraction means air from the interior of the plastic profile can be exchanged.

2. An extrusion line for producing plastic profiles, preferably plastic pipes, comprising at least
one extruder,
one die,
one calibration means,
and further following devices,
a chamber is arranged around the extruded pipe following the calibration means,
a fan being arranged on the chamber, by means of which fan air can be guided past the outer wall of the extruded pipe counter to the extrusion direction.

3. The extrusion line as claimed in claim 2 in which the extracted warm air can be fed to a consumer for energy recovery.

4. The extrusion line as claimed in claim 2 in which the chamber is sealed at least on one side.

5. The extrusion line as claimed in claim 3 in which the consumer is a heat exchanger.

6. The extrusion line as claimed in claim 3 in which the consumer is a preheating station for raw material to be fed to the extruder.

7. The extrusion line as claimed in claim 3 in which the consumer is a Stirling engine.

8. The extrusion line as claimed in claim 3 in which the consumer is an absorption cooling machine.

9. A method for extruding a plastic profile, in particular a plastic pipe, in an energy efficient manner, which method comprises the following steps:
a) melting of plastic in an extruder,
b) shaping of a plastic strand and feeding of the plastic strand to a die,
c) shaping of a plastic profile by means of the die, and
d) calibrating and curing by means of cooling of the profile in a calibration means,
the profile being cooled in the interior in addition to the outer cooling in the calibration means,
for the inner cooling of the profile, the air is sucked through counter to the extrusion direction by means of an extraction means.

10. A method for extruding a plastic profile, in particular a plastic pipe, in an energy efficient manner, which method comprises the following steps:
a) melting of plastic in an extruder,
b) shaping of a plastic strand and feeding of the plastic strand to a die,
c) shaping of a plastic profile by means of the die, and
d) calibrating and curing by means of cooling of the profile in a calibration means,
the profile being cooled in the interior in addition to the outer cooling in the calibration means,
for the outer cooling of the profile, the air is guided through a chamber past the outer wall of the extruded pipe counter to the extrusion direction by means of a fan.

11. The method as claimed in claim 10 further comprising feeding the air to a consumer in order to utilize heat.

12. The method as claimed in claim 10 further comprising extracting the air at least at a flow speed which lies in the turbulent range.

13. A method for extruding a thick-walled plastic pipe, in which the heat which occurs at the extruded pipe is fed to the extrusion process again, the obtained quantity of heat being utilized to preheat the raw material which is required for the extrusion process or to drive assemblies such as a Stirling engine.

14. The method as claimed in claim 9 further comprising feeding the air to a consumer in order to utilize heat.

15. The method as claimed in claim 9 further comprising extracting the air at least at a flow speed which lies in the turbulent range.

16. The extrusion line as claimed in claim 1 in which extracted warm air can be fed to a consumer for energy recovery.

17. The extrusion line as claimed in claim 16 in which the consumer is a heat exchanger.

18. The extrusion line as claimed in claim 16 in which the consumer is a preheating station for raw material to be fed to the extruder.

19. The extrusion line as claimed in claim 16 in which the consumer is a Stirling engine.

20. The extrusion line as claimed in claim 16 in which the consumer is an absorption cooling machine.
